(19) United States
(12) Patent Application Publication
(10) Pub. No.: US 2023/0306862 A1
(43) Pub. Date: Sep. 28, 2023

(54) LEARNING MANAGEMENT SYSTEM AND METHOD FOR CREATING AND PROVIDING CONTEXT-BASED PERSONALIZED LEARNING CONTENT

(71) Applicants: Roselyne HASTREITER, St. George (CA); Gerry PLANT, St. George (CA); Kirby JAMES, Oakville (CA)

(72) Inventors: Roselyne HASTREITER, St. George (CA); Gerry PLANT, St. George (CA); Kirby JAMES, Oakville (CA)

(21) Appl. No.: 18/125,312

(22) Filed: Mar. 23, 2023

(30) Foreign Application Priority Data
Mar. 28, 2022 (CA) 3153576

(51) Int. Cl. G09B 5/06; G06Q 50/20; G06F 16/28

(52) U.S. Cl. CPC G09B 5/065; G06Q 50/205; G06F 16/285

(57) ABSTRACT

A learning management system and method including a learning content management database. A server computer is connected to a computer network and the learning content management database. The server computer is configured to receive learning content, logically parse the learning content into micro-content, syntactically connect the micro-content, tag the micro-content, and store the micro-content in the learning content management database in a context-based fashion. The server computer further determines a learner's learning needs in a contextual fashion, determines learning content in dependence upon the learner's needs, retrieves context-based micro-content from the learning content management database, assembles the micro-content into a default learning pathway, and provides the micro-content to the learner in accordance with the default learning pathway.

This application claims priority to Canadian Application No. 3,153,576 filed on Mar. 28, 2022 and entitled LEARNING MANAGEMENT SYSTEM AND METHOD FOR CREATING AND PROVIDING CONTEXT-BASED PERSONALIZED LEARNING CONTENT, the entire contents of which are hereby incorporated by reference.

### FIELD

The present disclosure relates to learning systems and methods, and more particularly to a learning management system and method for creating and providing context-based personalized learning content.

### BACKGROUND

Present-day online learning systems are usually pre-recorded programs that lack a learner intake analysis and, therefore, are not tailored to meet an individual learner's needs. When a learner using today's online learning systems looks to learn a new skill, they have to attend or sift through hours of learning content just to find one gem of knowledge they are looking for.

At best, some present-day online learning systems provide a limited learner intake process based on keyword search and possibly demographic or psychographic data. For example, a learner is enabled to type in a keyword and the learning system suggests some learning lessons that are tagged with this keyword. However, to meet an individual learner's needs there are two pieces missing: ‘context’ of the learner's knowledge and ‘advisory’ recommending the knowledge to learn that meets the individual learner's needs.

Also, content creators spend a substantial amount of time creating and producing the learning content, only to discover that the learning content quickly becomes outdated and updating the same is difficult and time consuming, frequently requiring re-doing of an entire program when only a portion is outdated.

It may be desirable to provide a learning management system and method for creating and providing personalized context-based learning content.

It also may be desirable to provide a learning management system and method for creating and providing context-based personalized learning content that facilitates creation and updating of the learning content.

It also may be desirable to provide a learning management system and method for creating and providing context-based personalized learning content that is capable of assessing a learner's knowledge and tailoring the learning content to the learner's individual needs.

It also may be desirable to provide a learning management system and method for creating and providing context-based personalized learning content that is capable of dynamically assessing a learner's knowledge and dynamically tailoring the learning content to the learner's individual needs during the learning process.

It also may be desirable to provide a learning management system and method for creating and providing context-based personalized learning content that is capable of assessing a learner's knowledge and recommending learning content based on the learner's individual needs.

### SUMMARY

Accordingly, one aspect is to provide a learning management system and method for creating and providing personalized context-based learning content.

Another aspect is to provide a learning management system and method for creating and providing context-based personalized learning content that facilitates creation and updating of the learning content.

Another aspect is to provide a learning management system and method for creating and providing context-based personalized learning content that is capable of assessing a learner's knowledge and tailoring the learning content to the learner's individual needs.

Another aspect is to provide a learning management system and method for creating and providing context-based personalized learning content that is capable of dynamically assessing a learner's knowledge and dynamically tailoring the learning content to the learner's individual needs during the learning process.

Another aspect is to provide a system and method for creating and providing context-based personalized learning content that is capable of assessing a learner's knowledge and recommending learning content based on the learner's individual needs.

According to one aspect, there is provided learning management system. The learning management system comprises a learning content management database. A server computer is connected to a computer network and the learning content management database. The server computer is configured to receive learning content, logically parse the learning content into micro-content, syntactically connect the micro-content, tag the micro-content, and store the micro-content in the learning content management database in a context-based fashion.

According to one aspect, there is provided a learning management method. A learning content management database is provided, as well as a server computer connected to a computer network and the learning content management database. Using the server computer, learning content is received and logically parsed into micro-content. The micro-content is then syntactically connected, tagged, and stored in the learning content management database in a context-based fashion.

According to another aspect, there is provided a learning management system. The learning management system comprises a learning content management database having stored therein learning content as context-based micro-content. A server computer connected to a computer network and the learning content management database. The server computer is configured to determine a learner's learning needs in a contextual fashion, determine learning content in dependence upon the learner's needs, retrieve context-based micro-content from the learning content management database, assemble the micro-content into a default learning pathway, and provide the micro-content to the learner in accordance with the default learning pathway.

According to another other aspect, there is provided a learning management method. A learning content management database is provided, as well as a server computer connected to a computer network and the learning content management database. The learning content management database has stored therein learning content as context-based micro-content. Using the server computer a learner's learning needs are determined in a contextual fashion followed by learning content that meets the learner's learning needs. Context-based micro-content is then retrieved from the learning content management database and assembled into a default learning pathway. The micro-content is then provided to the learner in accordance with the default learning pathway.

An advantage of the disclosed system and method is that it provides a learning management system and method for creating and providing personalized context-based learning content.

A further advantage is that it provides a learning management system and method for creating and providing context-based personalized learning content that facilitates creation and updating of the learning content.

A further advantage is that it provides a learning management system and method for creating and providing context-based personalized learning content that is capable of assessing a learner's knowledge and tailoring the learning content to the learner's individual needs.

A further advantage is that it provides a learning management system and method for creating and providing context-based personalized learning content that is capable of dynamically assessing a learner's knowledge and dynamically tailoring the learning content to the learner's individual needs during the learning process.

A further advantage is that it provides a learning management system and method for creating and providing context-based personalized learning content that is capable of assessing a learner's knowledge and recommending learning content based on the learner's individual needs.

### BRIEF DESCRIPTION OF THE DRAWINGS

An embodiment of the present invention is described below with reference to the accompanying drawings, in which:

FIG. 1a is a simplified block diagram illustrating a computer system for providing the learning management system and method according to an embodiment;

FIG. 1b is a simplified block diagram illustrating a functional block structure of the learning management system according to an embodiment;

FIG. 2 is a simplified block diagram illustrating a legend for diagrams 1 to 4 of the learning management system according to an embodiment;

FIG. 3 is a simplified block diagram illustrating components of the ‘Learning Content Intake’ functional block (Diagram 1) of the learning management system according to an embodiment;

FIG. 4 is a simplified block diagram illustrating components of the ‘Learner Assessment’ functional block (Diagram 2) of the learning management system according to an embodiment;

FIG. 5 is a simplified block diagram illustrating components of the ‘Personalized Learning Content Generation/Provision’ functional block (Diagram 3) of the learning management system according to an embodiment;

FIG. 6 is a simplified block diagram illustrating components of the ‘System Governance & Administration’ functional block (Diagram 4) of the learning management system according to an embodiment;

FIG. 7 is a simplified flow diagram illustrating method blocks corresponding to the functional system blocks in FIG. 3 of the learning management system according to an embodiment;

FIG. 8 is a simplified flow diagram illustrating method blocks corresponding to the functional system blocks in FIG. 4 of the learning management system according to an embodiment;

FIG. 9 is a simplified flow diagram illustrating method blocks corresponding to the functional system blocks in FIG. 5 of the learning management system according to an embodiment; and

FIG. 10 is a simplified flow diagram illustrating method blocks corresponding to the functional system blocks in FIG. 6 of the learning management system according to an embodiment.

### DETAILED DESCRIPTION

Unless defined otherwise, all technical and scientific terms used herein have the same meaning as commonly understood by one of ordinary skill in the art to which the invention belongs. Although any methods and materials similar or equivalent to those described herein can be used in the practice or testing of the present invention, certain methods and materials are now described.

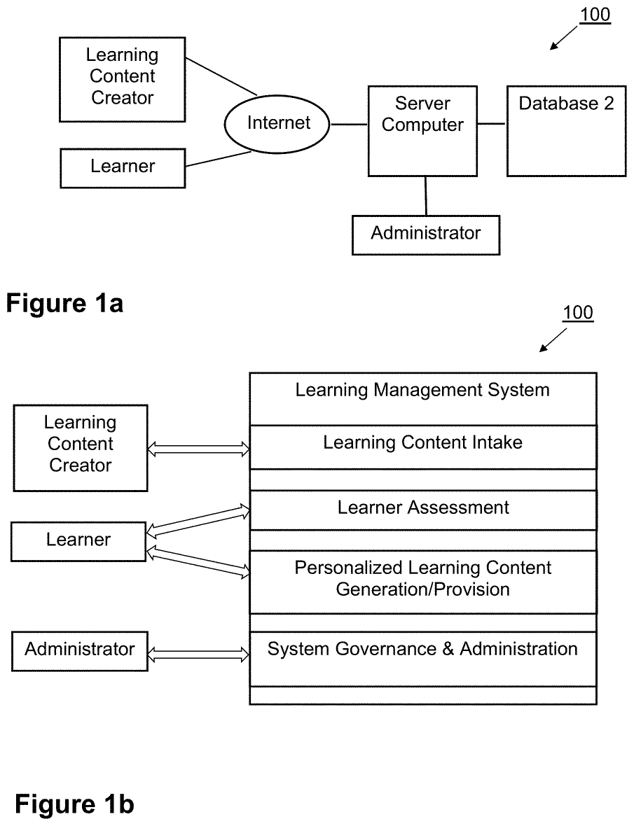

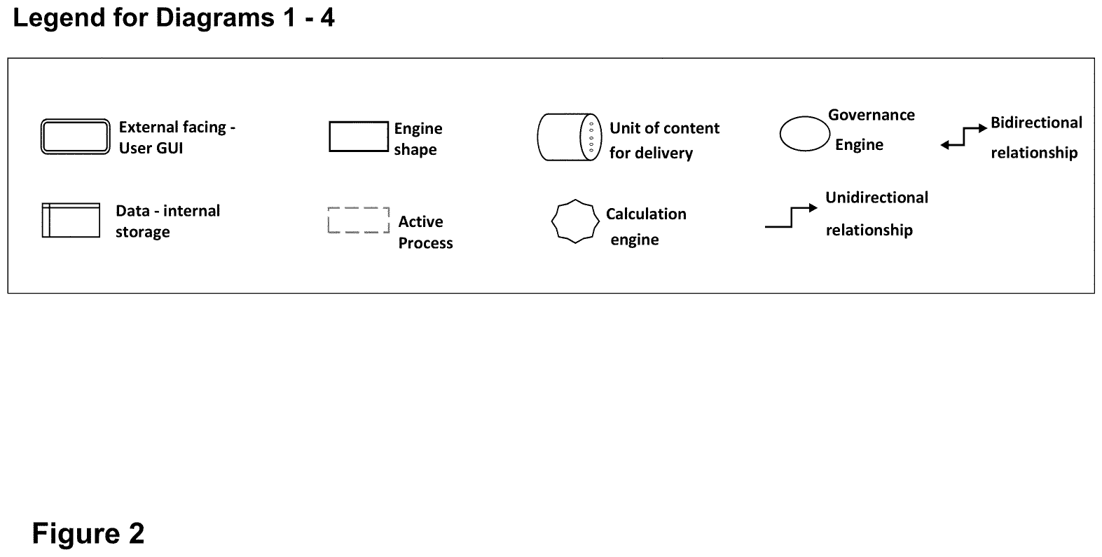

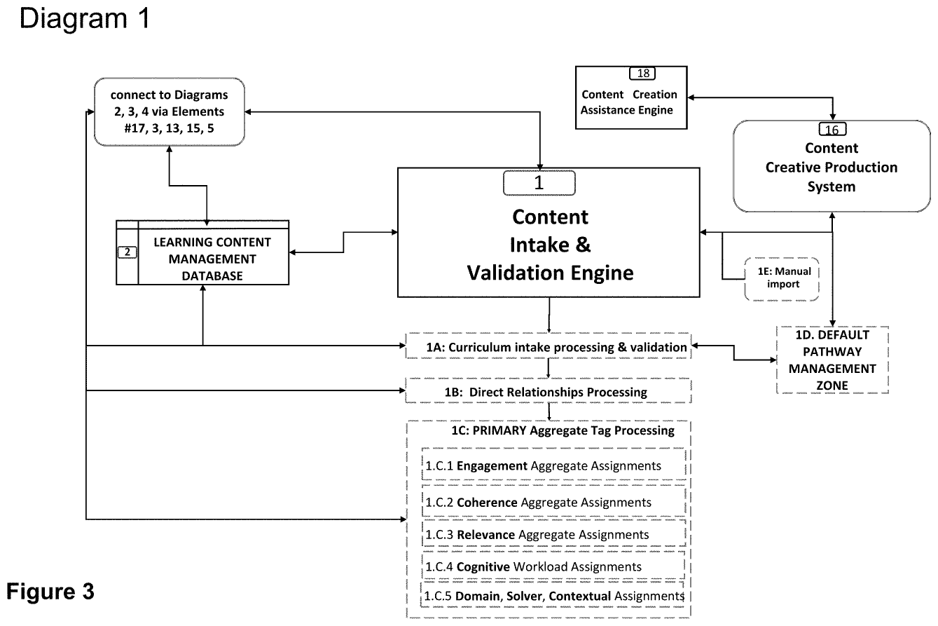

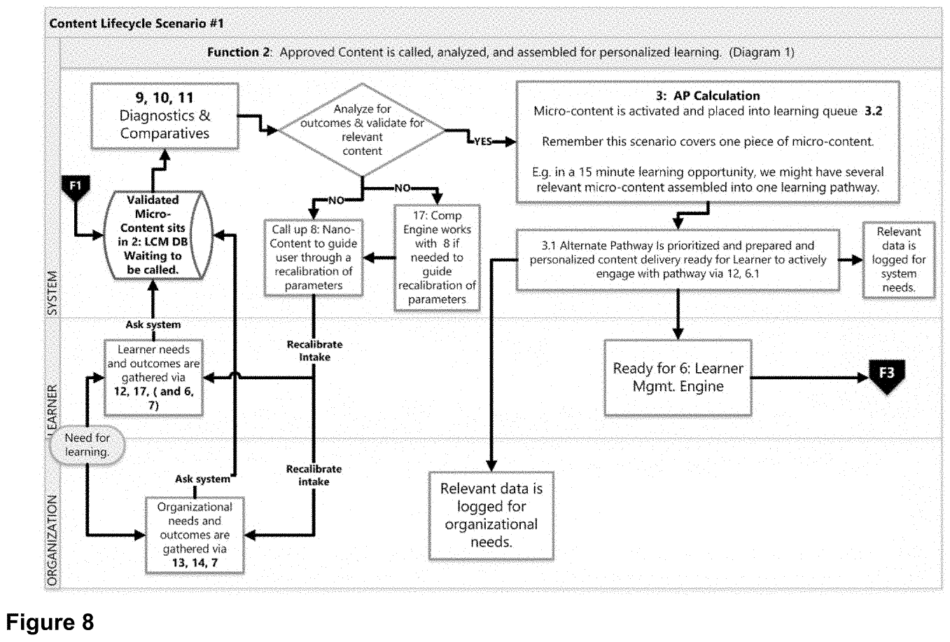

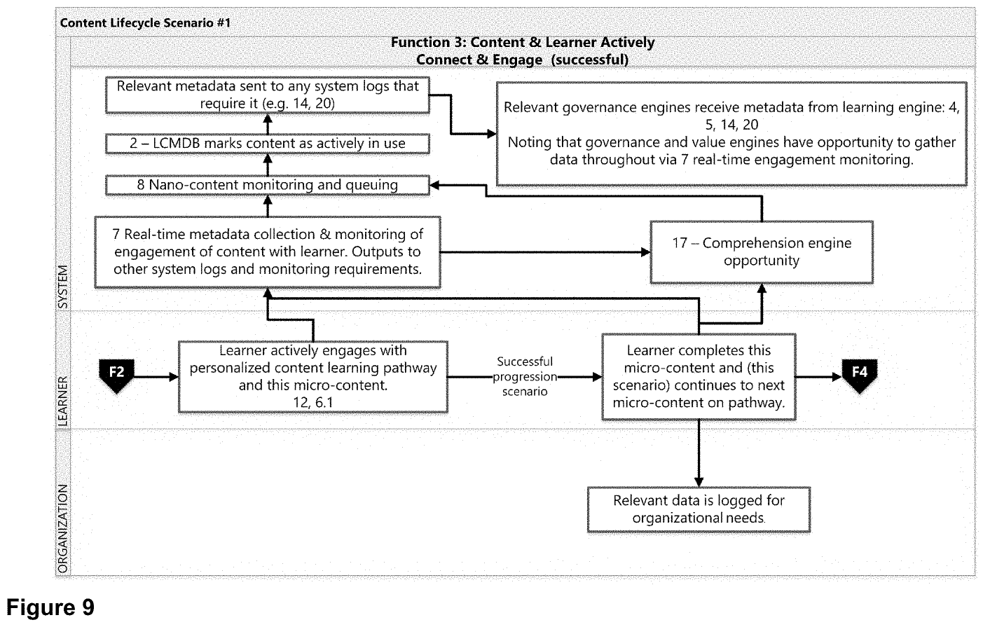

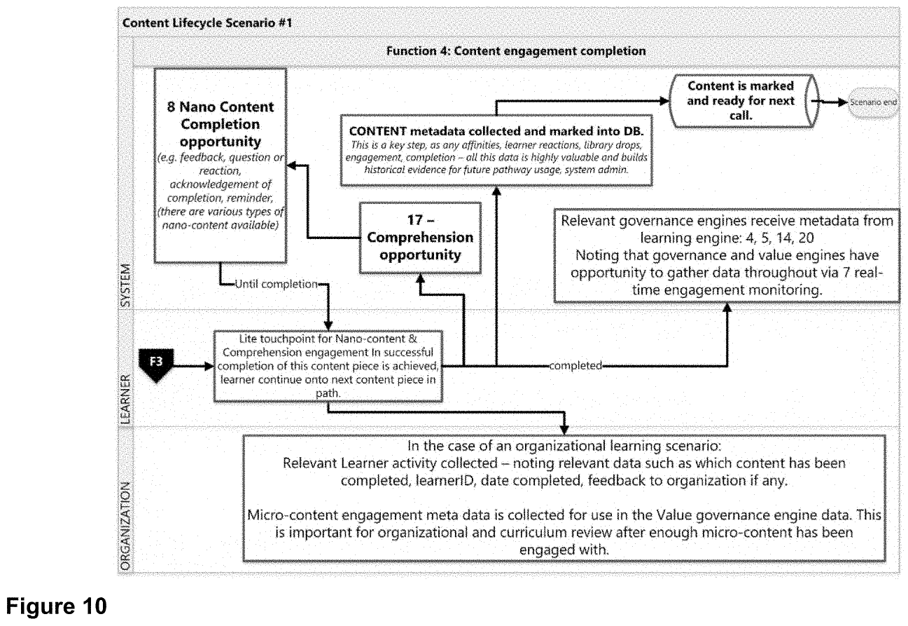

Referring to FIGS. 1a, 1b, and 2 to 10 a learning management system 100 for creating and providing context-based personalized learning content according to an embodiment is provided. The learning management system 100 is adapted to receive input learning content from learning content creators such as, for example, experts in various fields of knowledge.

The received input learning content is processed according to predetermined parameters prior storage thereof in a learning content management database 2 in the form of micro-content as granular context-based pieces of a larger knowledge set, as will be described hereinbelow. The context-based storage of micro-content substantially facilitates updating of the same as knowledge advances. Through the parsing process, topical, conceptual, or contextual gaps may be identified.

The system 100 executes a process comprising a series of steps that intakes a learner's contextual needs. Based on the learner's needs learning content is prepared and assembled into a default learning pathway which is optimized according to best practices as defined by associated subject matter experts. This default learning pathway may be further dynamically reassembled during the learning process.

The system 100 is implemented, for example, using a server computer connected to a database 2. The server computer is enabled to communicate with computers of the learning content creators and the learners connected to the Internet. A system administrator is also enabled to communicate with the server computer directly or via a communications network such as the Internet, as illustrated in FIG. 1a.

The server computer when executing executable commands stored in a non-transient or non-transitory computer storage medium such as, for example, a hard drive, performs the tasks of the learning system 100, as described hereinbelow, and including, for example, querying the database 2; establishing communication links; and managing learners'/content creators' accounts.

The database 2 is, for example, generated and operated using a standard SQL based database management system such as, MySQL, PostgreSQL, Oracle, or Sybase. The server computer is, for example, a standard server computer capable of executing a web server application such as, for example, the widely used web server software “Apache HTTP Server”. Optionally, the server computer comprises multiple processing modules with each processing module being associated with the processing of a specific task associated with a respective component of the learning system 100. The multiple processing modules may be implemented software based—multiple software platforms—or hardware based—multiple processors.

The dashboards are, for example, created as dynamic websites employing widely used software systems such as, for example, Common Gateway Interface (GGI), Java Servlets, or Java Server pages, and designed based on widely used Graphical User Interface (GUI) technology enabling the user to interact, for example, by clicking on selected icons, selecting from scroll down menus, and enter text into text fields. The dashboards can enable provision/receipt of “multimedia” such as, for example, audio, video, and animation, employing widely used Web browser plugins such as, for example, Adobe Flash, Adobe Shockwave, Microsoft Silverlight, and applets written in Java, or HTML 5 which include provisions for audio and video without plugins. The dashboards can be adapted to enable communication with users of various different types of client computers having Internet connectivity such as, for example, desktop computers, laptop computers, tablet computers, and smartphones. The dashboards can further be adapted to enable access to information from a different Internet domain than the server computer such as, for example, video sharing websites such as YouTube, connected to the Internet, using, for example, widely used hyperlinking technology.

The system 100 may be employed, for example, by an online learning service provider enabling learning content creators providing learning content to the system 100 and learners being assessed by and receiving learning content from the system 100 via the Internet, or by a larger organization for in-house training. As is evident to one skilled in the art, various other applications of the system 100 may be envisioned such as, for example, provision of one or more of the components of the system 100 and/or services based thereon in a Learning Tools Interoperability (LTI) compliant manner for integration into existing Learning Management Systems (LMS).

The system 100 as will be described hereinbelow is divided into four functional blocks:
a) Learning Content Intake (Diagram 1);
b) Learner Assessment (Diagram 2);
c) Personalized Learning Content Generation/Provision (Diagram 3); and,
d) System Governance & Administration (Diagram 4),
with each functional block comprising various components.

### Dictionary of Terms Used

Affinities Management Engine

This engine gathers and monitors patterns of content inter-dependencies between all learning content in the system; Outputs of this engine help inform the choice, assembly and sequencing of alternate pathways.

Affinity

a content relationship that is an indirect relationship, | Can be between topics or topical domains | e.g. a content segment on duration estimation could utilize a case study in which duration estimation was a peripheral aspect, but which still reinforces the concept

Aggregate Tag

This is a tag that is a “family” level of tagging content into large pools/sets | a parent tag that can hold multiple children tags | E.g. microcontent video is about Procrastination, and so the tag “procrastinate” will include a hierarchy of words/tags that this includes.

AI Assist

utilization of AI for general processing of content based on clear parameters with human oversight. This will allow for potentially bias inducing decisions to be audited.

AI Governance & Diagnostics Engine

An engine that produces data where authorized SMEs can review how the AI is being used throughout the system, as well as able to make adjustments to algorithmic equations used throughout. The purpose of this zone (includes a dashboard and ability to access reports and AI coding) is to ensure that we can—at any time—review how the AI is being used.

Algorithm

a process or set of rules to be followed in calculations or other problem-solving operations, especially by a computer.

Alternate Pathway (AP)

the selection and organization of content primarily based on system inputs | see Pathway

Alternate Pathway Calculation

the process of incorporating input variables (e.g. available learner time, specific topic, etc.) to determine an arrangement of content that best optimally responds to those inputs

AP Input Slider

a GUI element whereby a variable (e.g. time) can be set to develop an alternate pathway (AP)

API Integration Engine

Management zone that connects this system to any external applications programming interfaces (APIs)

Approved Learning Unit

A collection of micro and nano-content that has been prepared and sequenced by the relevant engines in preparation for learning.

Bias Review

the process of examining how content has been reassembled in order to determine whether unintentional bias has been introduced through any system process

Calculation Engine

Process(es) that uses calculations to provide outputs

Cognitive Workload

The level of exertion required to comprehend topic matter

Cognitive Workload Rating

a system of measurement based on topical difficulty and/or density of concepts. Allows the arrangement of content into a sprint/recovery format | Allows for counter-balancing of micro-content for best retention and engagement

Coherence Review

the process of ensuring that content has been reassembled in a way that maintains a sufficient degree of narrative and topical continuity as determined by content creator/SME

Compatibility

Validation against governance, logic, and technical spec rules throughout system, to ensure agreement and minimize potential for conflict between system elements.

Comprehension Engine

The purpose of this engine is to create valid questions to test for comprehension of learned content. This engine provides the ability to close the learning ecosystem through the provision of testing that validly evaluates understanding by the learner. Provides proof of competence in the application and understanding of selected content. Provides a means to respond to and validate learner claims of prior knowledge of selected content. Provides proof of prior knowledge, enable the learner to bypass material they already know, showing respect to their experience and understanding. As well it saves the employer time spent in learning by allowing learner to only consume material that is net new, or they do not adequately comprehend. Provides support for proof of compliance with regulatory requirements for training and comprehension.

Content Creation Assistance Engine

This engine assists curriculum designers with tutorials, support and guidance through the content creation/import process.

Content Creative Production System

GUI that assists curriculum developers import and/or produce new multimedia content (e.g. audio, record and edit video, assign library music, visual assets, exercises)

Content Intake & Validation Engine

An engine that imports, logically parses, syntactically connects and tags content in preparation for data housing and alternate pathway usage.

Context Tag

This is a tag that identifies a block of content to ensure it will be utilized in a way compatible with syntactic rules that relate to the learner's or organizational context

C-Type

Content-type=defines the type of microcontent that is set up within the system. Must adhere to syntax

Curriculum

the subjects comprising a course of study

Curriculum Change Request Management

The process through which curriculum change can be managed.

Curriculum Dashboard

This front-end GUI allows authorized curriculum SME to review and monitor relevant metrics and curriculum-relevant information.

Curriculum Designer

the content creator or SME (that creates the learning content)

Curriculum Performance

a statistical overview based on metrics (completion rates, comprehension, retention, etc.)

Dashboard

A visual control panel that allows an end-user to select, review, and interact with system.

Data Holding Centre

Any repository that holds data

Default Pathway

The standard fixed and linear arrangement of content, e.g. a Table of Contents of a book represents a default pathway

Delivery

The process of providing content through the system

Direct

as pertains to content relationships, any number of content blocks that have been determined must appear together in a specified arrangement (A before B, no B without preceding A, etc.)

Direct Relationships

as pertains to content relationships, any number of content blocks that have been determined must appear together in a specified arrangement (A before B, no B without preceding A, etc.)

Domain Tag

metadata that identifies whether a block of content belongs to a domain, or overarching topic (Project Management might be an example of such an umbrella domain)

Dynamic

the capacity of content arrangement to be recalculated (Alternate Pathway Calculation) on the fly in response to learner input

Dynamic Re-Assembly AP Calculation Engine

This is an engine where prepared microcontent is assembled in preparation for Alternate Pathway delivery. This is both a predictive (forecast) and responsive (dynamic) element of the system, that has multiple inputs, several points of analysis, with a result of a single and responsive output stream that is refreshed on a near-real-time basis into 3.1, 3.2.

The inputs from both Learner and Organizational engines, inputs from system engines (e.g. Relevance Coherence Engine), are matched and compared against inputs from the Intake and MicroContent production engines. The most relevant learning microcontent and nano-content suggestions are prioritized, flagged, and sequenced for output to the AP Calculations queue and holding center (3.1, 3.2), in preparation for active learner engagement.

Engagement

the degree to which a learner maintains connection with the material being presented

Engine

An internal set of mechanisms (coding, processes) that transform data (like fuel) into functional power for use within the HG system

Governance Engine

An engine that controls system rules and ensures compliance

GUI: Graphical User Interface

The visual interface that a user will engage with as part of their experience with the system.

HG Syntax

Logic rules that govern how the micro-content is coded and c-typed.

Intake

A way to import external content into the system, or to import new content created in the creative production system.

Integration Engine

An internal set of mechanisms that interface with external applications (e.g. CRMs, Learning Mgmt DBs, Security, Paywalls, cloud storage, SAS, any type of external-to-system software infrastructure that we would need to map outputs to, and collect relevant inputs from).

Learner

The person who is learning about a particular subject or how to do something.

Learner Dashboard

This front-end GUI allows the learner access to all relevant learner variables as well as elements such as (but not limited to): Individual desired outcomes and learning performance; library of courses taken and library of reference material; suggested learning; user-account profile settings; user-specific notes area; any learning supportive elements the system can provide the specific learner. This dashboard also will be the interface used for the learner to actively engage with the content.

Learner Management Engine

This engine gathers all learner variables and desired outcomes that are input by learner, as well as any results from learning assessments, organizational assessments that are relevant, as well as for our internal engines, a gathering of some aspects of user behavior with the learning system that are relevant to their learning style and needs.

Learner Outcome

The desired consequence/output of the learning experience (time and focus spent in learning and applying it)

Learning Content

Represents content that is used for learning experience. This can include micro-content and nano-content, as well as any external references used to support the learner.

Learning Content Management Database

This is where the processed and validated micro-content is stored, ready for use in the learning system.

Library & Lounge

A front end-GUI that allows learners and other relevant learning stakeholders (e.g. curriculum SMEs, other learners) to gather and engage with each other to continue discussion, live events, and engagement with social learning opportunities. This GUI also allows learners access to any relevant learning materials (just like a library). | Library—a repository of digital assets available to a learner | Lounge—an online meeting place for relevant stakeholders (e.g. learners, instructors) to meet, discuss, question and socially engage

Library Assets (audio/templates)

Any content or media that can be held for reference or usage in a learner's experience

LOGS

Learner Outcome Governance System—A series of rules that control the way content is processed to ensure governance

LOGS Engine

The engine that implements LOGS, Learner Outcome Governance System. This engine implements LOGS rules that entire system must adhere to, to ensure principles of data integrity and learner benefit.

Management Zone

A place where analysis, AI, and/or SME can engage with the system to manage and administer the components of the system

MC Creative Production System

A management zone where the creative production of learning content can be produced. (can be all forms of multi-media)

Meta-Data

data used to summarize basic information about a digital asset

Meta-Tagging

the process of applying metadata information to an aggregate of assets as a way to associate then into a set or subset (e.g. content creator, content type etc.)

Meta-Tagging Engine

This AI Assisted tagging engine assigns micro-content and nano-content with metadata that identify the nature and functional usage of the content for alternate pathway choice and assembly.

Metrics

measures of quantitative assessment used for comparing and tracking performance

Micro-Content

Short-form content that is used for this learning system.

MicroContentPredecessor

a block of content that, if present, must precede any other associated blocks of content

MicroContent Successor

a block of content who's presence is contingent on, and must follow, the content determined to have predecessor status (if A then B, if B then A, B must follow A)

Monitoring

The act of watching and controlling the system components in order to provide analysis support to operations and performance, and to help detect and alert about possible errors

Multi-Media

The use of a variety of artistic or communicative media. This can include (but is not limited by) video, audio, visuals, learning assists, text, links to other media

Nano-Content

a content type of very short duration designed to interact with other content blocks in a way that supports inter block continuity and reinforces the overarching teaching methodology

Nano-Content Real-Time Learning Assistant Engine

This engine responds to inputs from other engines that allow Nano-content to be delivered in a timely and responsive way. This engine helps drive and optimize the learner's experience through the learning pathway.

N-Type

Specific nano-type (see Nano TBL definitions)—that characterizes the function of the nano-content. Each N-type has a specific definition and purpose in assisting the learner through their learning pathway.

Organizational Performance and Administration Dashboard

GUI that provides monitoring and input from the Organizational perspective. E.g. Sliders for Organizational Learning preferences, Reporting, Learner metrics, Curriculum performance, meta-data engagement analysis, change request management, coherence review, primary zone for administration of learners. reporting of Value Delivery (See Value delivery governance engine)

Parsing

The process of analyzing a larger piece of learning content and then breaking it down into smaller chunks of usable micro-content

Pathway

a series of curriculum ‘steps’ created by content blocks either statically (in the case of a default ordering) or dynamically (in the case of input mediated content reassembly)

Pathway Sequencing

the order of multiple pathways determined by continuity preservation and teaching best practices

Primary

The foremost consideration/highest priority/most direct.

Production

The process/action of making or manufacturing learning content from components or raw materials

Queue

Input or output requests that are stored and arranged for retrieval in a prescribed order

Real-Time

relating to a system in which input data is processed within milliseconds so that it is available virtually immediately as an output

Real-Time Engagement Monitoring and Metadata Engine

This engine gathers and monitors relevant learner engagement metadata (e.g. completion rates, speed, gaps); monitors for thresholds that prompt micro-content assembly and nano-content usage; The outputs of this data allow for other engines to respond in a tailored way to each learner.

Re-Assembly

The action of putting content together in a relevant and coherent manner for learning consumption

Relevance & Coherence Engine

A series of processes dedicated to the optimization of learner and organizational relevance and coherence | Relevance: The quality or state of being closely connected or appropriate based on learner and organizational inputs | Coherence: A systematic consistency through logical or narrative connections. This engine is responsible for monitoring, analyzing and reporting on the relevancy and coherence of microcontent usage in alternate pathways.

Reporting & Exporting GUI

GUI for approved users (various permission sets) to choose, customize, format, print and export relevant and permitted data.

SME

Subject Matter Expert

Solver Tag

metadata that identifies whether a block of content belongs to a problem-solution category. E.g. “I need help with procrastination”=adds a text string and aggregate characteristic(s) of the term procrastination into the micro-content or nano-content's metadata

Syntactic Parsing

the process of content evaluation based on how they might fall into the various categories contained within the HG syntax phrase structure

Syntax

a set of rules that govern how the content is arranged for learning consumption

System Administration Dashboard

GUI that an approved system administrator uses to administer the technical aspects and back end of the system. Includes features such as reporting, diagnostics, log review, change management logs, profile administration, and relevant engine maintenance.

Tagging/Tag

Characteristics applied to content to help the system determine its potential for usage in learning pathways | metadata that helps the system process and calculate

Validation

A process that authenticates/proofs data against system rules

Value Delivery Governance Engine

This engine gathers, monitors, analyzes and delivers proof of learning value. This engine is a series of processes dedicated to the optimization of learner and organizational outcomes.

VAS: Value Analytic System

Using elite statistical analysis processes, deliver Proof of Value on ongoing basis for all aspects of HG

VMS: Value Measurement System

Meticulous design to deliver maximum impact with least steps, create statistically valid means to measure Value

VQS: Value Quantification System

Through market research, curriculum research and quantitative modelling, create a HG way to explain Value to Learners, Employers and Instructors

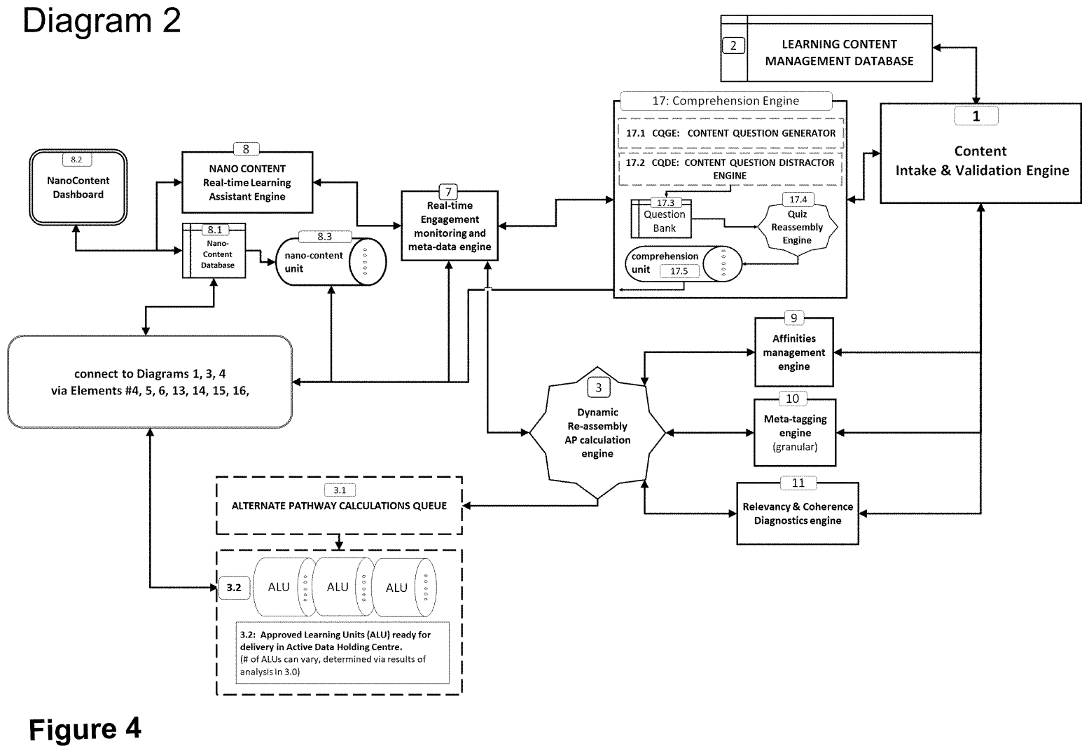

a) Learning Content Intake (Diagram 1 illustrated in FIG. 3)

1 Content Intake & Validation Engine

The Content Intake & Validation Engine 1 imports, logically parses, syntactically connects and tags content in preparation for data housing and alternate pathway usage. It intakes old or newly produced content and, with Artificial Intelligence (AI), production polishing (fade ins, outs) and automatic tagging and relationships, checks for intake compatibility, allows for parsing recommendations, sends reports to curriculum dashboard 15 and ensures compatibility with the system 100. It flags any content that is not compatible or within Learner Outcome Governance System (LOGS) governance rules.

Notable Direct Inputs
#16—Content Creative Production System
#1E: Manual Import of content
#15: Change requests and flags from Curriculum Dashboard
#2: Learning Content management Database data flags (potential issues as flagged and noted by the system)
#8: Nano-Content learning engine (feedback of performance data)

Relevant Performance data expected to flow-through from #2, #3, #4, #5, #6, #7, #13, and #14

Notable Direct Outputs/Results/Objectives
1) Validated content ready for process component #2
2) Content is parsed, aggregate meta-tagged
3) Compatibility achieved for use within the learning ecosystem
4) Relationships between content established
5) Content is syntactically assigned
6) Parsed content flagged and tagged for #17 Comprehension Engine use
7) Parsed content flagged and tagged for #9, #10, #11 granular processing
8) System data to #5 AI Governance, #20 System Admin for diagnostics/review
9) Re-calibrated/Updated data flow-through to relevant system dashboards

Notable Components/Functionality

Internal to Element 1: Content Parser (e.g. for Length, AI Parsing Assist),
AI Listener (to identify natural language for aggregate meta-tagging),
LOGS Validator,
Aggregate Tagger (Domain, Context, Solver, Engagement, Cognitive, Coherence, Relevancy),
Micro-Content Type assignments,
Nano-Content Type assignments,
Direct Relationships assignment,
Default Path assignments,
Hierarchical relationships,
Manual import ability from external source,
Granular data-mapping ability (e.g. external field to internal field mapping)

Internal/External-Facing

Internal

Notes on AI or Augmentation Intelligence that can be Incorporated

AI can support clustering and classification of content, (machine learning models that support clustering and classification of micro-content). There are many options and models today to choose from, such as, for example:
NLP: Natural Language Processing
Weak AI or Augmented Intelligence to support tagging (classification)
Computer Vision: For translation of images into text categories if needed
OCR: Optical Character Recognition (for existing content that is taken into the system)
Marking of specific content (in longer content sequences).
Noting: To save development time, existing software that auto-marks for words and end points (as per YouTube search functionality allows for segmented chapters to be highlit depending on text search) may be employed.

Notable Interdependencies

This is a core element to the process and all elements are interdependent.

The most direct noted above.

1A: Curriculum Intake Processing & Production Validation

Content is parsed into micro- or nano-content, checked against syntactic rules, marked for C-Type, N-Type, multi-media rules, LOG rules, |Natural Language AI Assist, |Media parsing AI assist

1B: Direct Relationships Processing

Micro-content is processed for direct relationships, based on syntactic rules and based on logic, AI assist, preparation for curriculum developer to validate what the system chooses for Direct content relationships.

E.g. Think of a Table of Contents, where there are certain sub-topics . . . . (help interpret)

1C: Primary Aggregate Tag Processing

Micro-content is assigned primary tags based on natural language AI assisted processing (e.g. frequency of terms used, comparatives against similar content). Preparation for validation-audit by SMEs/Curriculum developer.

1D: Default Pathway Management Zone

Micro-content is ordered in one or more linear arrangements, and these sequences of micro-content constitute default pathways (the standard fixed and linear arrangement of content, e.g. a Table of Contents of a book) in preparation for default pathway prioritization. Default pathway management allows curriculum developer to prioritize/re-arrange the order of topics/content based on their knowledge of who a generalized aggregate target audience would be. (E.g. if for a group of Senior managers, the content might be organized differently than for a group of new junior employees).

1E: Manual Import Option

Allows for manual import and mapping of external content into system. *Noting that #16 and #20 are dashboards assigned to handle the front-end functionality and visible import, whereas 1E is the backend allowing for the data to be processed. Any data not processed well by the #19 API integration engine, can be diverted to the manual import option for manual data mapping as needed

Notable Direct Inputs
#16—Content Creative Production System
#1E: Manual Import of content
#15: Change requests and flags from Curriculum Dashboard
#2: Learning Content management Database data flags (potential issues as flagged and noted by the system)
#8: Nano-Content learning engine (feedback of performance data)
Relevant Performance data expected to flow-through from #2, #3, #4, #5, #6, #7, #13, and #14

Notable Direct Outputs/Results/Objectives
1) Validated content ready for process component #2
2) Content is parsed, aggregate meta-tagged
3) Compatibility achieved for use within the learning ecosystem
4) Relationships between content established
5) Content is syntactically assigned
6) Parsed content flagged and tagged for #17 Comprehension Engine use
7) Parsed content flagged and tagged for #9, #10, #11 granular processing
8) System data to #5 AI Governance, #20 System Admin for diagnostics/review
9) Recalibrated/Updated data flowthrough to relevant system dashboards

Notable Components/Functionality
Internal to Element 1: Content Parser (e.g. for length, AI parsing assist),
AI Listener (to identify natural language for aggregate meta-tagging),
LOGS Validator,
Aggregate Tagger (Domain, Context, Solver, Engagement, Cognitive, Coherence, Relevancy),
Micro-Content Type assignments,
Nano-Content Type assignments,
Direct Relationships assignment,
Default Path assignments,
Hierarchical relationships,
Manual import ability from external source,
Granular data-mapping ability (e.g. external field to internal field mapping)

Internal/External-Facing
Internal
Notes on AI or Augmentation Intelligence that can be incorporated (if applicable)
AI can support clustering and classification of content, (machine learning models that support clustering and classification of micro-content). There are many options and models today to choose from, such as, for example:
NLP: Natural Language Processing
Weak AI or Augmented Intelligence to support tagging (classification)
Computer Vision: For translation of images into text categories if needed
OCR: Optical Character Recognition (for existing content that is taken into the system)

Notable Interdependencies
This is a core subset of functional processing for #1
2 Learning Content Management Database
The Learning Content Management Database 2 stores the processed and validated micro-content ready for use in the learning system 100.

Notable Direct Inputs
#1 Content Intake & Validation Engine
#15 Curriculum Dashboard
#13 Organizational Dashboard
Flowthrough data expected from all engines, as this is the central database that stores ready-to-use content

Notable Direct Outputs/Results/Objectives
Parsed and validated content is housed in preparation for processing through the system
Any flagging or performance tagging is received by specific content for processing and updates.
E.g. If micro-content is flagged to be updated via the organization dashboard, this database stores the attribute required for processing through #1 and #16.
E.g. If one micro-content is flagged for non-compliance by #1 Content Engine, this disables or marks content for non-use by the system)

Notable Components/Functionality
Content is housed in this database, as well as holds any relevant performance flagging and tagging needed for processing through the system.

Internal/External-Facing
Internal, with access via #20 System Admin Dashboard

Notes on AI or Augmentation Intelligence that can be Incorporated (if Applicable)
Help monitor and process change request escalation classification (inputs from other engines)
Help monitor usage and system data overall. (E.g. compliance flagging)

Notable Interdependencies
This is a core component for the entire process—outputs from other engines can indirectly impact learning content.
If content is flagged for non-use/replacement/updating, rules will be programmed to remove content from active streams and potential use until it has been replaced/updated.

16 Content Creative Production System
The Content Creative Production System 16 is a Graphical User Interface (GUI) that assists curriculum developers import and/or produce new multimedia content (e.g. audio, record and edit video, assign library music, visual assets, exercises)

Notable Direct Inputs
#1E: Manual import option of content intake
#18—Content Creation assistance engine

Notable Components/Functionality
Allows production and creation of content/multimedia

Internal/External-Facing
External

Notes on AI or Augmentation Intelligence that can be Incorporated (if Applicable)
Augmented/weak AI can assistant the content creation process with off-the-shelf licensable products that can be implemented.
As our system evolves in development, this engine will offer strong AI and Machine Learning towards using adult educational methodology application to curriculum development.

18 Content Creation Assistance Engine
The Content Creation Assistance Engine 18 assists curriculum designers with tutorials, support and guidance through the content creation/import process.

Notable Direct Inputs
#16—Content Creative Production System
#1—Content Intake and Validation
#8—Nano-Content Engine (to assist with content creator process)
(Influence of LOGs to ensure compliance, will allow this to prompt for typical input/creation inputs)

Notable Direct Outputs/Results/Objectives
Support for the creative production system—e.g. tips, onscreen support, onscreen flagging and notifications of potential thresholds/governance

Notable Components/Functionality
Onscreen support throughout the creative production process—outputs to #16, Content Creative Prod. System

Internal/External-Facing
Internal

Notes on AI or Augmentation Intelligence that can be Incorporated (if Applicable)
Augmented/weak AI can assistant the content creation process with off-the-shelf licensable products that can be implemented.
As our system evolves in development, this engine will offer strong AI and Machine Learning towards using adult educational methodology application to curriculum development.

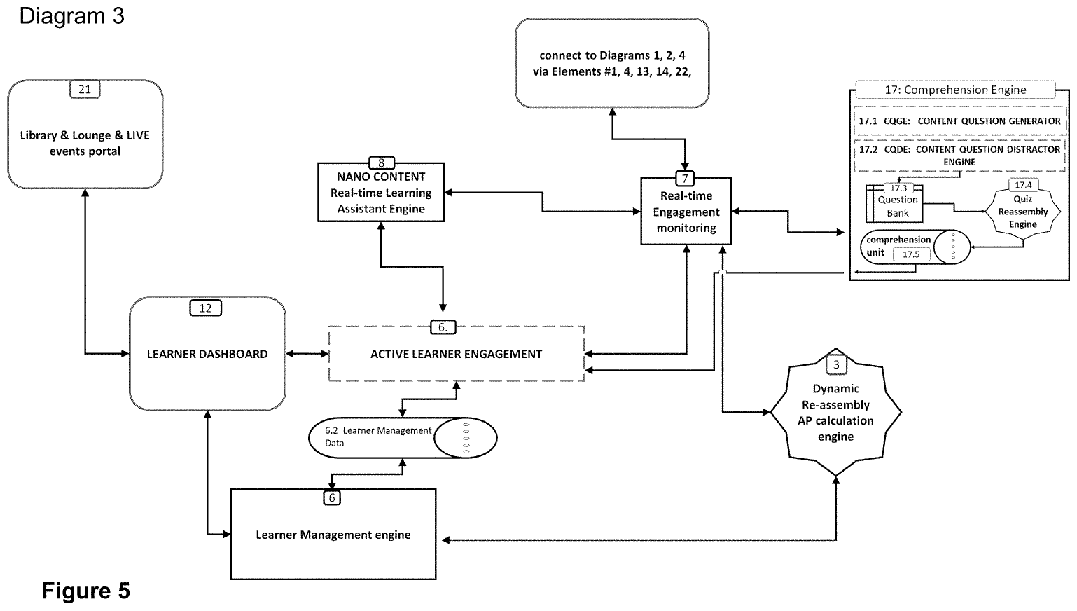

b) Learner Assessment (Diagram 2 Illustrated in FIG. 4)

1 Content Intake & Validation Engine
Described in a) hereinabove

2 Learning Content Management Database
Described in a) hereinabove

3 Dynamic Re-Assembly AP Calculation Engine

The Dynamic Re-Assembly AP Calculation Engine 3 is an engine where prepared micro-content is assembled in preparation for Alternate Pathway delivery. This is both a predictive (forecast) and responsive (dynamic) element of the system, that has multiple inputs, several points of analysis, with a result of a single and responsive output stream that is refreshed on a near-real-time basis into 3.1, 3.2.

The inputs from both Learner and Organizational engines, inputs from system engines (e.g. Relevance Coherence Engine), are matched and compared against inputs from the Intake and Micro-Content production engines. The most relevant learning microcontent and nano-content suggestions are prioritized, flagged, and sequenced for output to the AP Calculations queue and holding center (3.1, 3.2), in preparation for active learner engagement.

Notable Direct Inputs
#9 Affinities Management engine
#10 Meta-tagging engine
#11 Relevancy & Coherence Diagnostics engine
#4 LOGS
#7 Real-time engagement monitoring
#20 System admin dashboard

Bi-directional flow of performance information and relevant relational data

Notable Direct Outputs/Results/Objectives
Sequenced and relevant learning content for delivery to #3.1, 3.2, #6, #12
Forecasted Learning calculations into #3.1, which (indirectly) flows through to #8 Nano-Content, to help flag and prepare potential nano-content learning assistance content.
Performance and usage data for use in relevant engines such as #20 and #7

Notable Components/Functionality

This calculator is focused primarily on performing calculations of relevant and coherent learning pathways for learners actively involved the system.

Creates sample pathways to be used for testing, gap analysis, identifying sample learning paths for organizational review, identifying learning cases that will help refine content as well as any dashboard maintenance/upgrades and system analysis.

Internal/External-Facing
internal

3.1 Alternate Pathway Calculations Queue
The Alternate Pathway Calculations Queue 3.1 is a final stage output of the alternate pathway calculation engine 3, and is sequenced and assembled for delivery into a learning pathway

3.2 AP Data: Active Holding Center

This is where active alternate pathways are held in preparation for learning consumption.

Notable Direct Inputs
#3 Dynamic Re-assembly Engine (parent component of 3.1, 3.2)
#4 LOGS
#11 will have a stronger relationship into 3.1, for sequencing checks (coherency of learning path)

Notable Direct Outputs/Results/Objectives
Creates and forecasts alternate learning pathways and prepares for delivery
Actively holds learning units in preparation for delivery to #6 Learner Management Engine
Signals relevant prompts through to #6, which prompts #8 Nano Content for preparation of assisted learning
nano-content
Creates logs of data that are used for performance and system analysis in #20

Notable Components/Functionality

Active Data holding: active learning paths for queue and learning pathway forecasting

Sequencing

Internal/External-Facing
internal

Notes on AI or Augmentation Intelligence that can be Incorporated (if Applicable)
Augmentation and support of processing and sequencing and forecasting

7 Real-Time Engagement Monitoring and Metadata Engine

This engine gathers and monitors relevant learner engagement metadata (e.g. completion rates, speed, gaps); monitors for thresholds that prompt micro-content assembly and nano-content usage; The outputs of this data allow for other engines to respond in a tailored way to each learner.

Notable Direct Inputs
#3, #7, #6, #8, #14, #13, #17

Notable Direct Outputs/Results/Objectives
Core component of process.
Outputs sent through relevant system pathways to meet the purpose statement above, including but not limited to: #3, 4, 6, 8, 13, 14,

Notable Components/Functionality
Learner engagement monitoring
Metadata collection (e.g. completion rates, speed)
Monitoring for LOGS thresholds
Monitoring for thresholds that prompt content system to respond
Collecting data that can be used for governance engines

Internal/External-Facing
internal

Notes on AI or Augmentation Intelligence that can be Incorporated (if Applicable)
Augmented/Weak AI
Possible support in:
Interpretation of the learner inputs/meta data will need to organized in packets to inform multiple engines and therefore the AI ca reformulate/parse the outputs for each engine
Pattern/trend analysis, intelligent forecasting (beyond raw compilation), statistical probability outputs etc.
Help support monitoring and forecasting thresholds for governance

8 Nano Content Engine

This engine responds to inputs from other engines that allow Nano-content to be delivered in a timely and responsive way. This engine helps drive and optimize the learner's experience through the learning pathway.

Notable Direct Inputs
#1, Content intake
#7, Real-time Engagement monitoring
If learner calls up the Nanocontent, this would be via 7—so all other engine calls will flow through 7

Notable Direct Outputs/Results/Objectives
6, 6.1, 6.2, Learner Management engine
Ensure that the specific nano-content packets are forecast and delivered in a responsive fashion.

Notable Components/Functionality
Nano-content provides assistance to the learner's active learning pathway to help optimize the learning experience.

Internal/External-Facing
Internal, except for 8.2, which is dashboard and external facing

Notes on AI or Augmentation Intelligence that can be Incorporated (if Applicable)

Potential of developing strong AI/Machine Learning for this part of the process.

ML can help enhance semantically and contextually coherent nano-content the entire construct of the DrOC, in harmony with Instructor Objectives and Learner metadata will be required.
8.1 is storage where nano-content is stored, in preparation for delivery to learner.
8.2 is a place for a system administrator to create and manage nano-content that the system has available to use.
8.3 Nano-content is approved and prepared for delivery to the learner, in between learning paths.

9 Affinities Management Engine

This engine gathers and monitors patterns of content inter-dependencies between all learning content in the system; Outputs of this engine help inform the choice, assembly and sequencing of alternate pathways.

Notable Direct Inputs
#1—Content intake engine
#2—Learning Content DB
#3—Dynamic Re-assembly AP calculation—will work together to help find affinities
#7—Real-time Engagement monitoring and meta-data engine will (via #3) also influence the choices of topic affinity, as the learner continues to engage the system.

Indirectly, Governance engines #4, #5, #14—will have more direct influence over this engine

Notable Direct Outputs/Results/Objectives
Provide recommended topics that hold a strong affinity (based on system rules of delivery), to #3
Report back to the 1B: Direct Relationships processing to help flag any strong affinities in content DB

Notable Components/Functionality
Monitoring of content pattern inter-dependencies between all learning content in the system.
Acts to help filter content into #3 Dynamic re-assembly AP Calculation—to ensure strongest related learning topics are made available as a potential for learner to engage with.

Internal/External-Facing
internal

Notes on AI or Augmentation Intelligence that can be Incorporated (if Applicable)

For MVP we can use simpler logic equations to support affinities between lessons, but as this system grows, and as more user engagement data is collected, and analyzed, we anticipate ML will be employed to assist with scalability especially for larger data sets that have cross-domain relevancy potential. E.g. if a learner engages in a key lesson in time management on estimating duration, but then also shows a strong interest in the domain of project management tips, and engages in the lesson on how to estimate durations with a project team, our system allows for an affinity to be created between the two topics, even though they live in two distinct “workshop” domains.

This currently has been proven in our POC1, and is being addressed via a logical syntax as well as a POC1 relevancy equation, but as the system grows, the affinities engine will be able to provide guidance around the relationship between these two lessons, and offer it as a potential lesson to the learning pathway forecast, especially if the learned has indicated a strong desire towards project management learning.

10 Meta-Tagging Engine (Granular)

This AI Assisted tagging engine assigns micro-content and nano-content with metadata that identify the nature and functional usage of the content for alternate pathway choice and assembly.

Notable Direct Inputs
#1—Content intake engine
#1.C—Aggregate tagging assignments (Each micro-content has tags associated and scored to help provide learning content relevancy, coherence—this is a core component of the entire process and we created a proof of the concept in our POC1 via aggregate tag assignments and scoring to each learning content)
#2—Learning Content DB
#7—Real-time Engagement monitoring and meta-data engine will (via #3) also provide feedback to help influence the choices of granular topical tagging, as learners engage the system.

Indirectly, Governance engines #4, #5, #14—will have more direct influence over this engine

Notable Direct Outputs/Results/Objectives
Provide tagging of meta-data for the content—such as multiple contextual tags, provide a logical expansion and depth of granularity from the 1.C Aggregate tag assignments
Outputs to #3, as well as opportunity to provide feedback to 1.c.1-1.c.5 and any future aggregate assignment categories not shown in the overview diagram.

Notable Components/Functionality
Provide a level of granularity to the meta-tagging of each micro-content, so to help the system make better choices for tailoring learning pathways

Internal/External-Facing
internal

Notes on AI or Augmentation Intelligence that can be Incorporated (if Applicable)
Augmented/weak AI—To help process information from other engines

11 Relevancy & Coherence & Diagnostics engine

This engine is responsible for monitoring, analyzing, recommending content sequencing, and reporting on the relevancy and coherence of microcontent usage in alternate pathways.

Notable Direct Inputs
#3—Dynamic Re-assembly AP Calculation
#9, #10, via #3
#7—Engagement monitoring and meta-data engine (via #3)
#12, #6: Learner input provides data that #3 will process and send through to #11 to help with choosing and assembly of AP
#13—Organizational Dashboard will also have input into relevancy and desired outcomes, therefore this data will pass through for diagnostics

Must adhere to any governance provided by #4, #5, #14

Notable Direct Outputs/Results/Objectives
Provide analysis and optimized choice and sequencing for assembling into #3.1, #3.2, and is a key process component in developing the tailored learning pathways to be used in #6, #6.1, and eventually by the learner in #12.

Notable Components/Functionality
Key component in the overall process, as it helps diagnose the most relevant content as per the needs of the learner and organization as input and engaged.

Provides suggested re-assembly and coherence of micro-content

Internal/External-Facing
internal

Notes on AI or Augmentation Intelligence that can be Incorporated (if Applicable)
Augmented AI to help support diagnostics processing

17 Comprehension Engine

The purpose of this engine is to create valid questions to test for comprehension of learned content. This engine provides the ability to close the learning ecosystem through the provision of testing that validly evaluates understanding by the learner. Provides proof of competence in the application and understanding of selected content. Provides a means to respond to and validate learner claims of prior knowledge of selected content. Provides proof of prior knowledge, enable the learner to bypass material they already know, showing respect to their experience and understanding. As well it saves the employer time spent in learning by allowing learner to only consume material that is net new, or they do not adequately comprehend. Provides support for proof of compliance with regulatory requirements for training and comprehension.

Notable Direct Inputs
#1—Content Intake & Validation
#3—Dynamic Re-assembly AP calculation
#7—Real-time engagement monitoring
#13—Organizational Performance & Admin Dashboard

Notable Direct Outputs/Results/Objectives
Outputs relevant and approved comprehension questions through to #6, #8, #12,
Interfaces with #13 and relevant output to governance engines (Value, LOGs, AI) and reporting engine (#22)
Outputs of questions can be output to dashboards (depending on the situation, some questions may require organizational approval, therefore would appear on #13, 15, and #12)

Notable Components/Functionality

As part of the digital component of helping provide practical and value towards learner competency, this engine has the responsibility of ensuring sophisticated approach to questions for learners to engage with throughout their learning experience. Depending on the situation, this engine can be used at a learner intake, learner touchpoint, and/or end of segment to help provide support to learner comprehension and experience.

Internal/External-Facing
Internal (with outputs throughput to relevant dashboards)

Notes on AI or Augmentation Intelligence that can be Incorporated (if Applicable)
Augmented/weak AI, NLP, computer vision and OCR to review curriculum to extract content for question and distractor formulation

17.1

The location where comprehension questions are generated. There are a variety of inputs that can help generate the question structure: for example, can be provided manually (via SME); can be generated via existing content; can be independent of what the curriculum SME can generate such as external questions from a body of knowledge pre-generated to help assess learner competence with a particular domain; can be assembled via machine-learning algorithm. Sets up the opportunity to generate a relevant and coherent question to help prove comprehension through a learner's knowledge and experience.

17.2

The engine that generates question distractors that can be made available throughout a learner's experience to aid in proof of comprehension. (In psychometry, a question distractor's purpose is to provide a reasonable cue or diversion created within a proof-of-comprehension stream to help challenge the learner's comprehension). As in 17.1 hereinabove, there a variety of ways that distractors can be input and/or generated.

17.3

Data storage of all generated question and distractor assets, as well as their performance metrics used in delivery.

17.4

The location where comprehension questions and distractors are chosen and assembled in a relevant and coherent fashion in preparation for the next delivery for the learner to engage with, for example, several quiz questions/distractors assembled in a fashion that can be delivered at the next comprehension opportunity.

17.5

An approved set of questions and question distractors assembled and ready for delivery into a learner's experience.

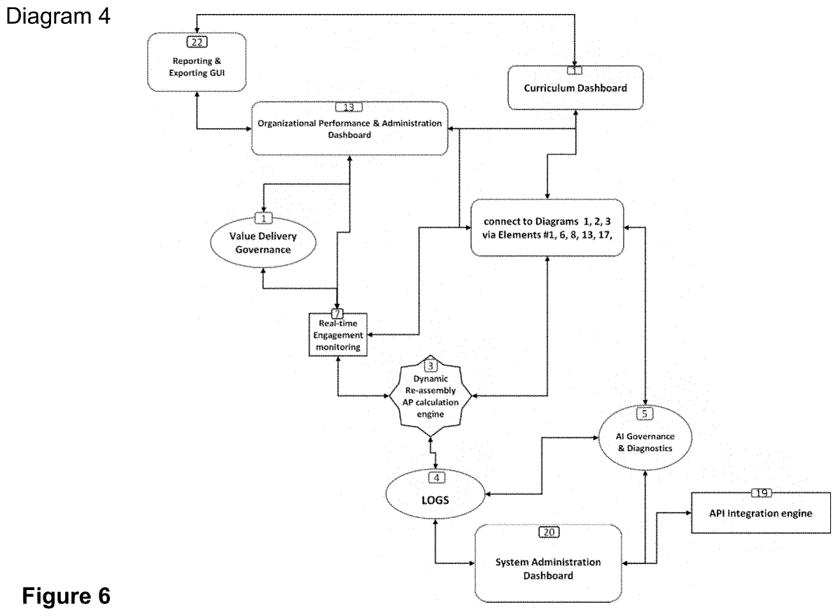

c) Personalized Learning Content Generation/Provision (Diagram 3 illustrated in FIG. 5)

3 Dynamic Re-Assembly AP Calculation Engine
Described in b) hereinabove

6 Learner Management Engine

This engine gathers all learner variables and desired outcomes that are input by learner, as well as any results from learning assessments, organizational assessments that are relevant, as well as for our internal engines, a gathering of some aspects of user behavior with the learning system that are relevant to their learning style and needs.

Notable Direct Inputs
#3 (and 3.1, 3.2)—AP Dynamic Reassembly engine
#12 Learner Dashboard
#6.1, 6.2 Active learner engagement sub processes

Notable Direct Outputs/Results/Objectives

Delivers information through system pathways to ensure Learner variables and relevant data are delivered in a responsive manner to (but not limited to): #3, #7, #8, #17, #20, #14, #13, #21, #22, and indirectly to all governance systems that are used in monitoring learner's experience with intention to optimizing their learning experience.

Notable Components/Functionality

This engine delivers the learning paths, so this is a core component to the relationship between the learner and the content, as well as between the learner's engagement and the system.

Ensures that Leaner management data (6.2) and active learner engagement (6.1) is processed efficiently and prepared for system flow-through.

Internal/External-Facing
Internal engine—with data that feeds through system pathways to relevant external dashboards

Notes on AI or Augmentation Intelligence that can be Incorporated (if Applicable)
Augmentation to support multiple processes through system pathways.

Notable Interdependencies
Core component to the system process.

7 Real-Time Engagement Monitoring and Metadata Engine
Described in b) hereinabove

8 Nano Content Engine
Described in b) hereinabove

12 Learner Dashboard

This front-end GUI allows the learner access to all relevant learner variables as well as elements such as (but not limited to): Individual desired outcomes and learning performance; library of courses taken and library of reference material; suggested learning; user-account profile settings; user-specific notes area; any learning supportive elements the system can provide the specific learner. This dashboard also will be the interface used for the learner to actively engage with the content.

Notable Direct Inputs
#6—Learner management engine (this is where the data from #3, 8, and 17 is flowed and managed through)
#21—Library & lounge/Live events portal—E.g. notifications
#22—Reporting and Exporting GUI

Notable Direct Outputs/Results/Objectives
#6.1—Active Learning Engagement—As learner engages with content, engagement data is collected
#8 (via #6)—specific calls to Nano-content (by Learner input—e.g. if time input is lowered by learner, then the nano-content will respond at end of time segment).
#7—Real-time Engagement (via the #6)—essential engagement data is a primary objective so that the system can tailor a response to future learning pathways

Notable Components/Functionality
Allows learner to engage with the lessons
All elements of the learning plan, desired outcomes, learner choices (e.g. time, context, domain interest), all available to the learner.
Any learner element that is useful for the learner (e.g. library, references)

Internal/External-Facing
External GUI

Notes on AI or Augmentation Intelligence that can be Incorporated (if Applicable)
Augmentation to help with recommendations, nano-content assistance, forecasting/recommendations for future learning.

17 Comprehension Engine
Described in b) hereinabove

21 Library & Lounge

A front end-GUI that allows learners and other relevant learning stakeholders (e.g. curriculum SMEs, other learners) to gather and engage with each other to continue discussion, live events, and engagement with social learning opportunities. This GUI also allows learners access to any relevant learning materials (just like a library).

Notable Direct Inputs
#12, #13, #15—As this is a social learning opportunity zone, as well as live events portal for learners and instructors/organizational curriculum developers/facilitators to engage directly with learners and learning communities
Notable influence of #3—in that if forecasted or recommended learning pathways are not engaged, but has high value potential and relevancy for the learner, or anything from active learning pathways that were flagged, stopped, or directed elsewhere (e.g. based on learner interest moving elsewhere, or to a recommended affinity topic given results of comprehension, learner recap, or time constraint case where the learner has to stop mid-way through a lesson for example)—or any learning materials that are recommended for the learner to review at a later date, or if the student simply wants to hop into the library for a deep-dive on the content, this location in the system allows for this interfacing between the content and the learner—much like a real-world library and student lounge area.

Notable Direct Outputs/Results/Objectives
Ability to engage as a learning community—As all learning is both social and emotional, this piece of the process is essential for people to be able to discuss and engage, as part of any optimized online learning process, as well as support live event opportunities that can be streamed/participated in.

Notable Components/Functionality
Interactivity between learning groups and facilitators
Ability to ask questions, view reference material, “lounge” to hang out and review various cases, and build professional network via the learning experience.

Internal/External-Facing
External (with internal monitoring via #6, #7) and governance engines.

Notes on AI or Augmentation Intelligence that can be Incorporated (if Applicable)
Significant potential to use a range of AI to create interactive avatars that embody the desired culture of the workplace. Values/cultural context would be brought in and through NLP, various AI enable interaction in support of organizational goals.
For curriculum designer, a possible avenue for NLP/AI to evaluate results of organizational assessments (e.g. culture surveys/market surveys/employee surveys) to suggest possible topics for future curriculum development

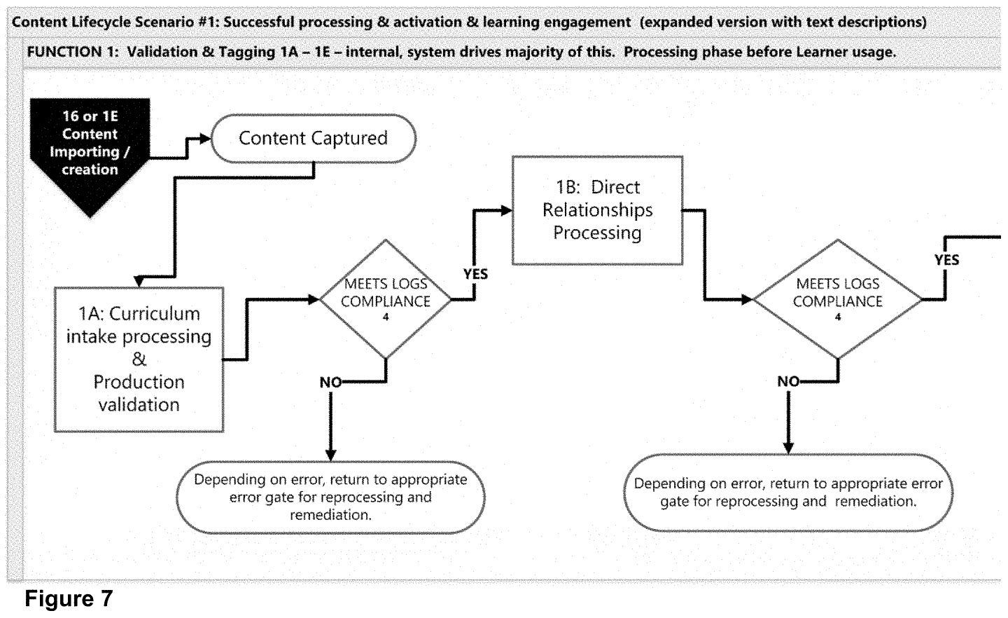

d) System Governance & Administration (Diagram 4 illustrated in FIG. 6)

3 Dynamic Re-Assembly AP Calculation Engine
Described in b) hereinabove

4 LOGS Engine
The engine that implements LOGS, Learner Outcome Governance System. This engine implements LOGS rules that entire system must adhere to, to ensure principles of data integrity and learner benefit.

Notable Direct Inputs
As this is a systemic governance engine, it has direct and indirect inputs from core engines such as, but not limited to, #1, #3, #5, #6, #7, #8, #14, #17, #20

Notable Direct Outputs/Results/Objectives
As this is a systemic governance engine, it has direct and indirect outputs and directives to core engines such as, but not limited to, #1, #3, #5, #6, #7, #8, #14, #17, #20
This engine is a key governance engine that ensures compliance of all rules deployed into the system and its interrelationships.
This is also the location of where security compliance will be monitored (as part of monitoring for industry standard compliances, this is the natural location of where we'll monitor security performances, and flag for any issues that are recommended by external security advisory.)

Notable Components/Functionality
Rules will continue to be refined as this system is developed. What matters in the process is that a LOGs is implemented in order to ensure proper compliance to internal rule sets as needed.

Internal/External-Facing
Internal but some elements will flag into the dashboards if compliances are not met.

Notes on AI or Augmentation Intelligence that can be Incorporated (if Applicable)
Augmentation to support multiple processing needs in a near-real-time/responsive design.

Notable Interdependencies
Core component to entire process.

5 AI Governance & Diagnostics engine
An engine that produces data where authorized SMEs can review how the AI is being used throughout the system, as well as able to make adjustments to algorithmic equations used throughout. The purpose of this zone (includes a dashboard and ability to access reports and AI coding) is to ensure that we can—at any time—review how the AI is being used.

Notable Direct Inputs
Core governance engine to help manage any AI that is used throughout the system.

Notable Direct Outputs/Results/Objectives
#20, for system admin review, analysis and maintenance
#4, for LOGs compliance checks
Various logs to show how the AI is being used throughout the system

Notable Components/Functionality
All logs are prepared for review to support auditability of AI
Where possible and relevant, adjustments to AI functionality made available to authorized system administrators.

Internal/External-Facing
Internal, with #20 dashboard proposed as primary review external

Notes on AI or Augmentation Intelligence that can be Incorporated (if Applicable)
The AI that is used to support the AI governance engine may be focused primarily on capturing relevant system data in a responsive manner.

Notable Interdependencies
Core governance engine.

7 Real-Time Engagement Monitoring and Metadata Engine
Described in b) hereinabove

13 Organizational Dashboard
This front-end GUI allows for any organizational administrator to review elements such as (but not limited to): learning metrics, performance, curriculum analysis, curriculum change requests, learner feedback, and overall administration of organizational learning group.

Notable Direct Inputs
#2—Learning content management database
#15—Curriculum Dashboard
#14—Value Delivery Gov. Engine
#7—Real-time engagement monitoring and meta-data engine
#17—Comprehension Engine
#22—Reporting
#21—Library/Lounge/Live Events
#6, #12—From learner to organization—messaging, information, requests, communication pathway

Notable Direct Outputs/Results/Objectives
Sends input through to #3 for optimal tailoring of learning pathways
Feedback into supporting and input engines—e.g. Review of Value=outputs into #14, Change request for curriculum=feeds back through to #15, #2, #1, #16
#17—Comprehension Engine—(e.g. approval of key questions, request to add question)
#7—Real Time Engagement: Organization has system engagement that needs to be monitored for other engines (e.g. Logs, security, change requests, contextual input)
#6, #12—Communication pathway through to learner

Notable Components/Functionality
This is the component that allows an organization to interact with the entire system and with the learner, content and curriculum development.

Internal/External-Facing
external GUI

Notes on AI or Augmentation Intelligence that can be Incorporated (if Applicable)
Augmentation/weak AI to help with interfacing with system, content, and learners.

14 Value Delivery Engine
This engine gathers, monitors, analyzes and delivers proof of learning value. This engine is a series of processes dedicated to the optimization of learner and organizational outcomes.

Notable Direct Inputs
#7—Real-time engagement monitoring and meta-data engine
#13—Organizational Performance & Admin Dashboard
Relevant Data flows through #7—learner feedback, active engagement, comprehension, to help evaluate proof of learning value.

Notable Direct Outputs/Results/Objectives
Evaluations of learning value that are reported out to system engines and #22—reporting
This is a core governance engine that helps optimize learner and organizational experiences

Notable Components/Functionality
Value engine provides monitoring and proof of learning value to the system as well as diagnose gaps in value, and ensure quality measurement.
E.g. If the content is not deemed of value to a learner, we need to know so that value gaps can be addressed

Internal/External-Facing
Internal

Notes on AI or Augmentation Intelligence that can be Incorporated (if Applicable)
Predetermined arrangement of value definitions coupled with augmented AI to perform calculations or call on 3^{rd} party software (e.g. Minitab) to process outputs of predetermined calculations and graphical analysis

15 Curriculum Dashboard
This front-end GUI allows authorized curriculum SME to review and monitor relevant metrics and curriculum-relevant information.

Notable Direct Inputs
#2—Learning Content Management Database
#13—Organizational Dashboard
#1—Content intake & Validation Engine

Notable Direct Outputs/Results/Objectives
#2, #13, #1, #17—The Curriculum Dashboard assists curriculum developers/SMW to review and monitor relevant performance/engagement metrics, and is a way for engines to be able to have a repository to review compliance (governance) or change requests.

Notable Components/Functionality
front-end dashboard that allows approved users to interact with the curriculum towards helping provide SME input into how the curriculum is delivered and optimized.

Internal/External-Facing

External
Notes on AI or Augmentation Intelligence that can be Incorporated (if Applicable)

Augmentation/Weak AI to assist with interfacing and system processing.

19 API Integration Engine
Management zone that connects this system to any external applications programming interfaces (APIs)

Notable Direct Inputs
Various potential inputs—for the purpose of this system, we anticipate approval and security protocols as well as compliance that needs to be approved prior to system entry—therefore we'll mark #20 as the throughpoint.

Notable Direct Outputs/Results/Objectives
Interface with the system depending on the types of APIs that are chosen at any given time. For example, an organization may have an HR application, or a Customer Service program that this system will need to interface with. Must allow enough option for custom programming in order to bridge between our learning ecosystem and tailored organizational systems.

Notable Components/Functionality
as above. Noting also a major security compliance zone—this must be a key point of consideration during development.

Internal/External-Facing
Internal

Notes on AI or Augmentation Intelligence that can be Incorporated (if Applicable)
Possible security AI support—to ensure monitoring of external application behavior inside any relevant internal systems. Possible monitoring support as to any other external AI that is being used, so that it meets governance and compliance in #4, #5 engines

20 System Administration Dashboard
GUI that an approved system administrator uses to administer the technical aspects and back end of the system. Includes features such as reporting, diagnostics, log review, change management logs, profile administration, and relevant engine maintenance.

Notable Direct Inputs
This is a core component of the system, and therefore must have transparent access and flow through to all components in this process.

Notable Direct Outputs/Results/Objectives
This is a core component of the system, and therefore must have transparent access and flow through to all components in this process. This is critical for maintenance, support, and administration of overall system.

Notable Components/Functionality
Authorized system administrators are able to monitor and maintain system.

Internal/External-Facing
internal and external to authorized system administrators only.

Notes on AI or Augmentation Intelligence that can be Incorporated (if Applicable)
Augmentation/Weak AI to assist with interfacing and system processing.

22 Reporting & Exporting GUI
GUI for approved users (various permission sets) to choose, customize, format, print and export relevant and permitted data.

Notable Direct Inputs
As this can be a core component of the entire system—this reporting zone allows all users to prepare and print reports and export relevant and approved data. NOTE: System administration reporting is recommended to live within #20 so that risk is mitigated in terms of security.

Notable Direct Outputs/Results/Objectives
Information/analysis/reporting/exporting—basic functionality of any system, as well as option to customize reports (based on user permissions)

Notable Components/Functionality
Ease of use with pre-made reports
Ability to customize reports (e.g. pivoting approved fields)

Internal/External-Facing
External facing GUI

Notes on AI or Augmentation Intelligence that can be Incorporated (if Applicable)
Possible augmentation/weak AI to assist user in creating reports and suggested options for reporting based on analysis (e.g. value thresholds being met, may feed through to this dashboard for an organizational administrator to print)—TBD on how we might implement AI in this system, as for the MVP we'll use standard reporting models, and as development grows, we can consider AI to help.

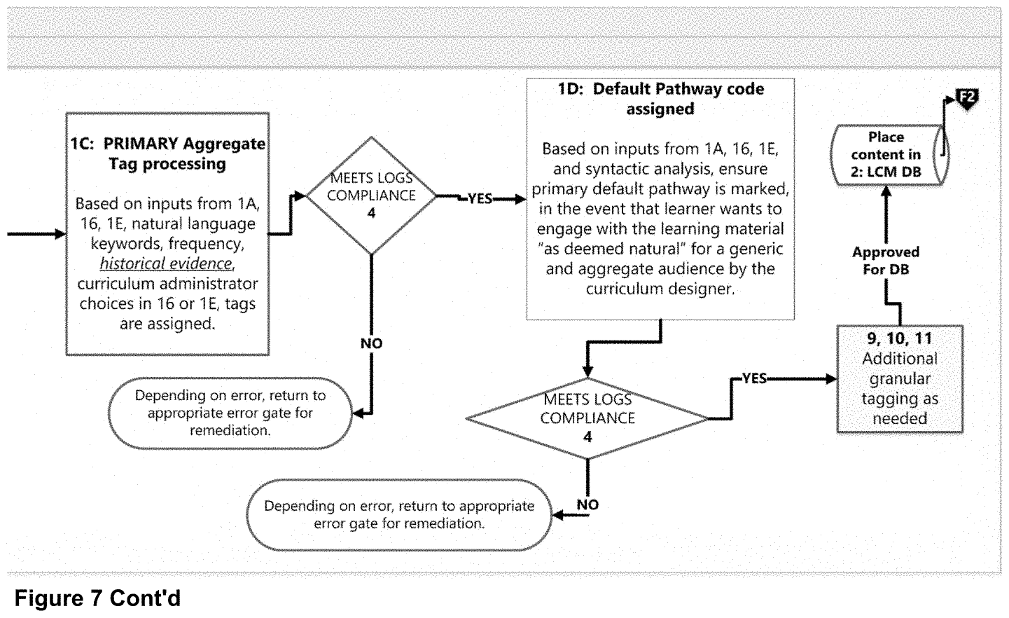

Referring to FIGS. 7 to 10, a learning management method for creating and providing context-based personalized learning content according to an embodiment is provided employing the system 100. The method is divided into four functional blocks corresponding to the functional system blocks described hereinabove with FIGS. 7 to 10 describing method blocks corresponding to system blocks a) to d), respectively.

The present invention has been described herein with regard to certain embodiments. However, it will be obvious to persons skilled in the art that a number of variations and modifications can be made without departing from the scope of the invention as described herein.

What is claimed is:

1. A learning management system comprising:
a learning content management database; and
a server computer connected to a computer network and the learning content management database, the server computer being configured to perform operations including:
receiving learning content;
logically parsing the learning content into micro-content;
syntactically connecting the micro-content;
tagging the micro-content; and,
storing the micro-content in the learning content management database in a context-based fashion.

2. A learning management method comprising:
providing a learning content management database;
providing a server computer connected to a computer network and the learning content management database; and
using the server computer performing:
receiving learning content;
logically parsing the learning content into micro-content;
syntactically connecting the micro-content;
tagging the micro-content; and,
storing the micro-content in the learning content management database in a context-based fashion.

3. A learning management system comprising:
a learning content management database having stored therein learning content as context-based micro-content; and
a server computer connected to a computer network and the learning content management database, the server computer being configured to perform operations including:
determining a learner's learning needs in a contextual fashion;
determining learning content in dependence upon the learner's needs;
retrieving context-based micro-content from the learning content management database;
assembling the micro-content into a default learning pathway; and,
providing the micro-content to the learner in accordance with the default learning pathway.

4. A learning management method comprising:
providing a learning content management database having stored therein learning content as context-based micro-content;
providing a server computer connected to a computer network and the learning content management database; and
using the server computer performing:
determining a learner's learning needs in a contextual fashion;
determining learning content in dependence upon the learner's needs;
retrieving context-based micro-content from the learning content management database;
assembling the micro-content into a default learning pathway; and,
providing the micro-content to the learner in accordance with the default learning pathway.
